(19) United States
(12) Patent Application Publication
(10) Pub. No.: US 2003/0184490 A1
(43) Pub. Date: Oct. 2, 2003

(54) Sectorized omnidirectional antenna

(76) Inventors: Clifford E. Raiman, Roselle, IL (US); Jerry C. Posluszny, Stickney, IL (US)

Correspondence Address: SEYFARTH SHAW, 55 EAST MONROE STREET, SUITE 4200, CHICAGO, IL, 60603-5803, US

(21) Appl. No.: 10/107,615

(22) Filed: Mar. 26, 2002

(51) Int. Cl. H01Q 21/20; H01Q 1/12

(52) U.S. Cl. 343/799; 343/890

(57) ABSTRACT

An omnidirectional, multiple unit antenna comprises a mounting assembly and a plurality of sector antennas carried on the mounting assembly. Each sector antenna is active to send or receive signals primarily through an angular, horizontal sector having an angle of no more than about 180° around the mounting assembly. The sector antennas carried on the mounting assembly are positioned so that sectors of the respective antennas cover substantially all horizontal directions. Each sector antenna preferably has a separate input, for improved control.

### BACKGROUND OF THE INVENTION

In various types of modern communication needs there are applications which need sector antennas. These antennas are usually available with azimuth beamwidths of 60 degrees or 90 degrees. The elevation beamwidths may be that which is required to produce gains typically from 12 dbi up to a value on the order of 20 dbi. Typically, arrays of separate printed circuit board patch antennas are used.

These sector antennas of the prior art are individually mounted to provide 360° coverage in azimuth, with access to individual 60° sector antennas being provided by individual circuits leading to the antennas. These separate, multiple antennas consume expensive labor in their installation, and are costly in other ways.

### DESCRIPTION OF THE INVENTION

In accordance with this invention, an omnidirectional antenna is provided, which antenna comprises: a mounting assembly, and a plurality of sector antennas carried on the same mounting assembly, each sector antenna being active to send or receive signals primarily through an angular, horizontal sector having an angle of no more than 180° around the mounting assembly. The sector antennas carried on the mounting assembly are positioned so that the sectors of the respective antennas cover substantially all horizontal directions, with each sector antenna having a separate input, so that signals may be separately sent or received through each individual sector antenna.

The sector antennas may be mounted on the mounting assembly radially around a common center, so that the mounting assembly and sector antennas are together carried on a mounting pole or equivalent device for elevating the antenna.

The mounting assembly for the sector antennas may be enclosed in a single radome, made of a known dielectric material having maximum transparency to the frequency of the antenna signals for sending or receiving.

Each sector antenna may preferably have an angular, horizontal sector of about 45° to 120°. Sector angles of 60° or 90° are commonly used. This means that, typically, from 3 to 8 sector antennas may be carried on the mounting assembly to provide a single, omnidirectional sectorized antenna assembly.

The specific types of sector antennas which may be used are not limited in any particular way. For example, printed circuit board patch antennas may be used, or dipole antennas, or any other desired antenna effective for this particular purpose. Each sector antenna may be an omnidirectional antenna which carries a reflector which is shaped to provide the desired sector for the antenna. Other sector antennas used herein may be unidirectional corner reflector antennas if desired, or any other type.

The plurality of sector antennas carried on the mounting assembly may be positioned in a plurality of groups which respectively occupy different levels along the combined antenna assembly (also called an “antenna” herein). Typically, the sector antennas of each level respectively have sectors that cover substantially all horizontal directions, so that the gain in various directions may be increased by the use of multiple antennas of different groups having sectors of similar direction. Each of the sector antennas may have its own printed circuit board combiner so as to feed each sector antenna's sent or received signal elements in phase together, to produce a higher gain by effectively reducing the vertical beamwidth while maintaining a desired azimuth coverage of the sector. Thus two to four levels of sector antennas, or more, may be used as desired to achieve the above.

Such antennas can be configured to produce vertical polarization, horizontal polarization, and also circular polarization. It would be possible to have one or more levels of the sector antennas to be vertically polarized while one or more levels of such sector antennas are horizontally polarized, for adjustment of the antenna performance.

Typically, all of the sector antennas emit or receive signals at the same frequency. However, it would be possible under appropriate circumstances to use different frequencies among various of the sector antennas present.

The mounting assembly and the sector antennas may together be carried on a mounting pole or pipe of conventional design. The wires or cables that connect with the respective sector antennas may be enclosed within the pipe, or they may extend downwardly in a manner surrounding the mounting pole or pipe.

The antennas as used in this invention may be enclosed in a single radome for protection from the elements, with the radome being of relatively small size, since the antennas are clustered together, typically being mounted radially around a common center as stated above.

Accordingly, a space-saving, effective multiple antenna is provided, which is far more easily mounted than a group of separate, directional antennas, and which may be better protected within a single radome, preferably with compact mounting of the sector antennas radially around a common center.

### DESCRIPTION OF THE DRAWINGS

FIG. 1 is a plan view of one embodiment of an omnidirectional, multiple antenna in accordance with this invention;

FIG. 2 is an elevational view of the antenna of FIG. 1;

FIG. 3 is a plan view of another embodiment of the omnidirectional, multiple antenna of this invention;

FIG. 4 is an elevational view of the antenna of FIG. 3, showing its connection to a mounting pole;

FIG. 5 is a plan view of the antenna of FIG. 3, with the top portion of the radome removed;

FIG. 6 is an elevational view of the antenna of FIGS. 3-5 with a side portion of the radome removed.

### DESCRIPTION OF SPECIFIC EMBODIMENTS

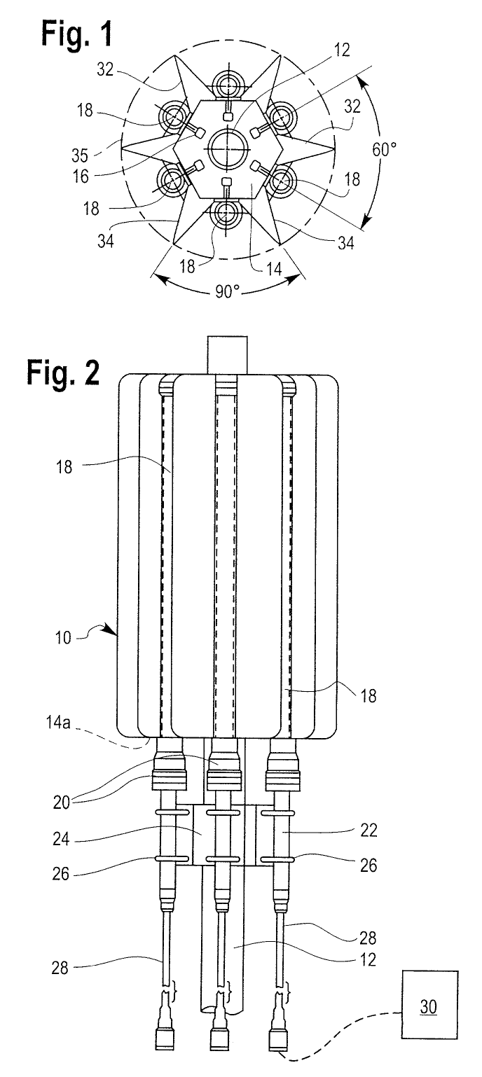

Referring to FIGS. 1 and 2, an omnidirectional, multiple antenna 10 is shown. Antenna 10 is mounted upon a vertical mounting pipe 12, to vertically elevate the antenna to permit good 360 degree reception and transmission. Mounting pipe 12 may be conventionally attached to the top of a building, a power transmission tower, a pole, or any other structure to provide both securance and sufficient elevation to the mounting pipe 12 to hold antenna 10 in a place where clear, unhindered transmission and reception can be achieved.

The mounting assembly comprises in this embodiment at least one mounting plate 14, which is carried on mounting pipe 12, and attaches by a conventional connection 16 to a plurality of antennas 18, six in number in this present embodiment, with the antennas comprising in this particular embodiment omnidirectional, high gain antennas made of fiberglass-covered copper wire elements. The copper wires of antennas 18 connect through rubber boots 20 which, in turn, each connect to an aluminum mounting tube 22. Each tube 22 is firmly secured to a mounting bracket 24 carried on the pipe 12 by U-bolts 26. Wire or cables 28 extend through the aluminum mounting tube and respectively each connect with a separate, fiberglass-covered antenna 18. Each wire or cable 28 then can connect each to its own independent circuitry 30, one of which is shown, for independent control and monitoring of each of the antennas 18.

Typically, another hexagonal mounting plate 14a is provided at the bottom of the radially-disposed array of antennas 18, with antennas 18 being secured to it in a manner similar to their securance to mounting plate 14, for firm, permanent retention of the antennas 18.

Also, secured with each of the antennas 18 are aluminum plate reflectors 32, which cooperate together so that each of two reflector members 32, which are V-shaped in cross section, form approximately 90 degree reflector surfaces 34 around each of the antennas 18. In other words, each antenna 18 is placed between an angled surface 34, with each of the two surfaces 34 adjacent to each antenna 18 presenting an angle of approximately 90 degrees to each other, with antenna 18 positioned in between. Thus, emissions from each antenna 18 are reflected to turn each omnidirectional antenna 18 into a sector antenna having an azimuth of its sector of transmission and reception of about 60 degrees. The six of these equidistantly-spaced, radial antennas cover the entire 360 degree azimuth surrounding the antenna.

If desired, antenna 10 will be enclosed in a radome 35, which is transparent to the signals emitted or received, to protect the antenna. Since the assembly of the antenna as shown in FIG. 2, for example, can be performed at the factory under optimum conditions, the on-site installation of this antenna is much easier and cheaper than conventional sector antennas, where individual installation of the various sector antennas is required in the field.

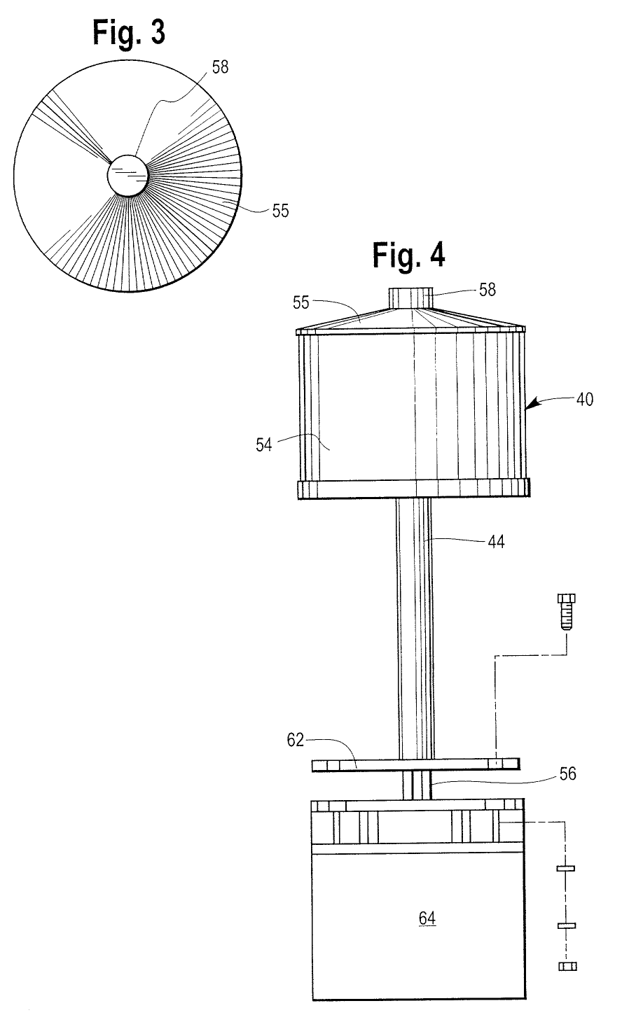

Referring to FIGS. 3-6, another embodiment of omnidirectional, multiple unit antenna array 40 is shown comprising a mounting assembly 42 carried on a first pipe or pole 44, and carrying a plurality of sector antenna units 46 of the unidirectional, small corner reflector type. Reflectors 48 may be utilized similar to those used in the previous embodiment, the reflectors being of the approximately 90 degree type.

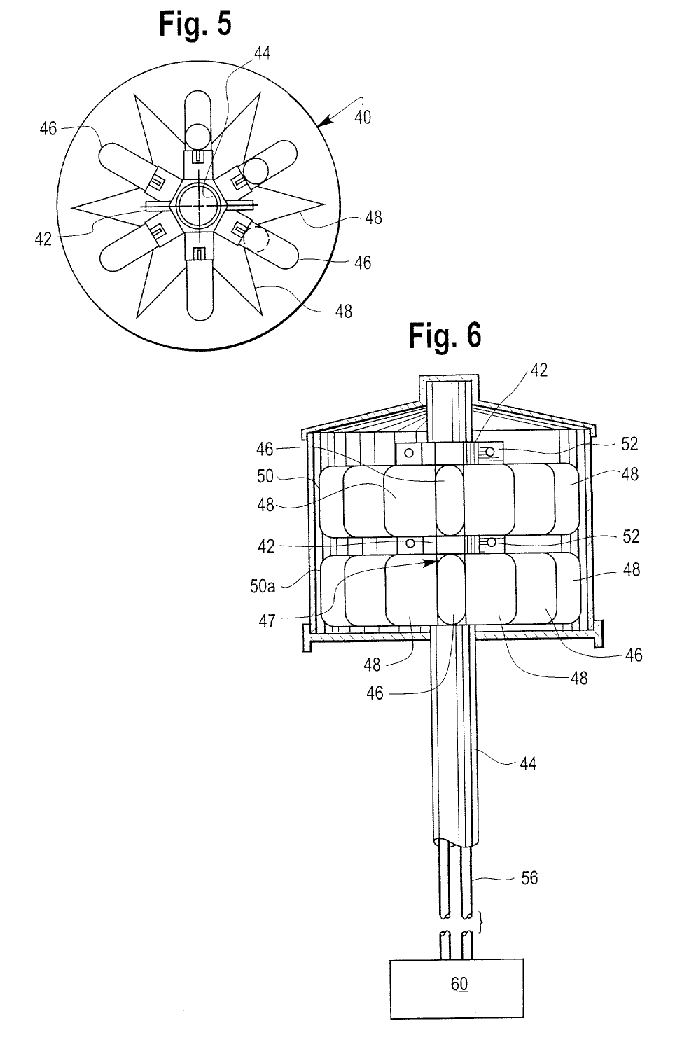

In this embodiment, more than one level 50, 50a of radially-disposed antenna units 46 is provided, to increase the gain. The number of levels may be chosen in accordance with the desired amount of gain increase. Thus, six sector antenna units 46 in this embodiment are shown to be in each single level 50, being distributed in a generally equal 60 degree pattern of distribution, and being bracketed by 90 degree reflector walls 48 as shown in FIG. 5 similar to the previous embodiment. The assembly may be carried by bracket 42, which comprises a pair of bracket halves with adjoining tabs 52, for bolting the bracket halves together with a frictional pressure retention about pipe 44, which carries antenna 40. The antenna assembly of antenna units 46 and reflector walls 48 may be carried on pole 44 by bracket 42 in this manner. This array is surrounded and protected by a radome 54, having a closed-top piece 55 and a recess 58 to receive the upper end of pipe 44.

In this embodiment, the wires or cables 56 each individually and respectively connect with all antenna units 46 in one vertical row or layer of sector antennas at one wire end and connect at the other end to an individual sector combiner 60. Wires or cables 56 extend through the interior of pipe 44, so that vertical row 47 of sector antenna units 46 may be separately controlled in both transmission and reception of signals. Thus each vertical row 47 comprises a separate antenna made of antenna units 46. Thus, each vertical pair 47 of sector antenna units 46 in the various levels 50, 50a may be commonly controlled with common circuitry, while the adjacent sector antenna units of the same level 50, 50a may be separately controlled with separate circuitry.

Alternatively, each antenna unit 46 may be separately controlled.

Pipe 44, being a part of the antenna 40 may be relatively short, and may have apertures extending through bottom plate 62 for connection to a larger, second pole 64, optionally of substantial length, with wires or cables 58 running through the interior of pole 64 also, to optionally extend through the interior of the lengthy pole 64 to enter into communication with the ground nearby or at some other remote location.

Thus, an omnidirectional, multiple unit antenna is provided, having the advantages described above for greatly reduced installation cost, permitting protection of multiple antenna elements under one radome 54.

The above has been offered for illustrative purposes only, and is not intended to limit the scope of the invention of this application, which is as defined in the claims below.

That which is claimed is:

1. An omnidirectional multiple unit antenna, which comprises:
a mounting assembly; and
a plurality of sector antennas carried on the mounting assembly, each sector antenna being active to send or receive signals primarily through an angular, horizontal sector having an angle of no more than 180° around the mounting assembly, the sector antennas carried on the mounting assembly being positioned so that the sectors of the respective antennas cover substantially all horizontal directions, each sector antenna having a separate input.

2. The antenna of claim 1 in which each sector antenna has an angular, horizontal sector of 45° to 120°.

3. The antenna of claim 1 in which from three to eight sector antennas are carried on the mounting assembly.

4. The antenna of claim 1 in which each sector antenna is a printed circuit board patch antenna.

5. The antenna of claim 1 in which each sector antenna is an onmidirectional antenna plus a reflector shaped to provide the desired sector for each sector antenna.

6. The antenna of claim 1 in which each sector antenna is a unidirectional, corner reflector antenna.

7. The antenna of claim 1 in which said plurality of sector antennas are positioned in a plurality of groups which respectively occupy different levels along the antenna.

8. The antenna of claim 7 in which the sector antennas of each level respectively have sectors that cover substantially all horizontal directions.

9. The antenna of claim 8 in which said sector antennas are each respectively connected to a printed circuit board combiner to combine sector antenna signals together in phase to provide increased gain.

10. The antenna of claim 7 in which each group of sector antennas produces signals having vertical, horizontal, or circular polarization.

11. The antenna of claim 10 in which at least one of said groups is vertically polarized and at least one of said groups is horizontally polarized.

12. The antenna of claim 7 in which said sector antennas are mounted radially about a center.

13. The antenna of claim 1 in which all of said sector antennas remit or receive signals at the same frequency.

14. The antenna of claim 1 in which said sector antennas are enclosed in a radome.

15. The antenna of claim 1 in which said sector antennas are dipole antennas.

16. The antenna of claim 1 in which said mounting assembly and sector antennas are together carried on a mounting pole.

17. The antenna of claim 16 in which said mounting assembly and sector antennas are enclosed in a single radome.

18. The antenna of claim 17 in which said sector antennas are mounted radially around a center.

19. The antenna of claim 1 in which said sector antennas are mounted radially around a center.

20. An omnidirectional, multiple unit antenna, which comprises:
a mounting assembly; and
a plurality of sector antennas carried on the mounting assembly, each sector antenna being active to send or receive signals primarily through an angular, horizontal sector having an angle of no more than 180° around the mounting assembly, the sector antennas carried on the mounting assembly being positioned so that the sectors of the respective antennas cover substantially all horizontal directions, each sector antenna comprising an omnidirectional antenna plus a reflector shaped to provide the desired sector for each sector antenna, said sector antennas being radially mounted around a center and each sector antenna having a separate input.

21. The antenna of claim 20 in which each sector antenna has an angular, horizontal sector of 45° to 120°.

22. The antenna of claim 21 in which from three to eight sector antennas are carried on the mounting assembly.

23. The antenna of claim 21 in which said plurality of sector antennas are positioned in a plurality of groups which respectively occupy different levels along the antenna.

24. The antenna of claim 23 in which the sector antennas of each level respectively have sectors that cover substantially all horizontal directions.

25. The antenna of claim 20 in which said sector antennas produce signals having vertical, horizontal, or circular polarization.
